(19) United States
(12) Patent Application Publication
(10) Pub. No.: US 2023/0305948 A1
(43) Pub. Date: Sep. 28, 2023

(54) END-TO-END COMPUTER SYSEM TESTING

(71) Applicant: Lenovo (United States) Inc., Morrisville, NC (US)

(72) Inventors: Matthew Fardig, Boonville, IN (US); Dane Hixson, Eden, UT (US); Timothy Robbins, Avon, IN (US); Sathish Kumar Ganesan, Tampa, FL (US)

(21) Appl. No.: 17/689,731

(22) Filed: Mar. 8, 2022

(51) Int. Cl. G06F 11/36

(52) U.S. Cl. CPC G06F 11/3668

(57) ABSTRACT

A software process is tested using an instance of a computer system. A first set of data and a second set of data are collected. The first set relates to resources used by the software process during the testing and the second set relates to conditions of the instance during the testing. A machine learning algorithm is trained with the first set of data and the second set of data, thereby generating a model relating to the resources used by the software process under the conditions of the instance. User input is received, the user input relates to expectations of a test plan for the software test. The test plan is created as a function of the model and the user input.

### TECHNICAL FIELD

Embodiments described herein generally relate to end-to-end computer system testing, and in an embodiment, but not by way of limitation, optimizing end-to-end computer system testing, and in a further embodiment, optimizing end-to-end computer system testing in a cloud environment as a function of cloud resources and cloud operating conditions.

### BACKGROUND

Running end-to-end tests for a large computer system project can be a very costly and time-consuming task. In current computing environments, cloud-based instances are often used to spin up resources that can be used as end-to-end test clients. Each instance that is spun up has costs associated with it (e.g., per minute billing, minimum charges per instance, etc.). When attempting to organize end-to-end tests, a lot of computing resources that are paid for go unused. For example, a test might be assigned to run on an instance, but it only uses 50% of the resources on that instance, and the user must pay for the entire instance. Additionally, these tests are often constrained by rules such as “Test A must complete before Test B can start,” or “Test C cannot run at the same time as Test D.” Trying to maximize the paid-for instances becomes nearly impossible in an environment in which hundreds of tests need to be run.

If speed is the most important factor in the testing, then more instances are used. More instances running the tests ensures that the testing process takes less time, however more costs are incurred (paying for startup time, paying for minimal billing thresholds, paying for features such as public IP addresses, etc.). If cost is the most important factor, time is sacrificed to avoid additional costs for starting up multiple instances. This often results in using as few instances as possible to avoid extra costs associated with more instances. However, the entire testing cycle takes longer to complete.

Also, running multiple tests on the same instance (whether in parallel or sequentially) requires a lot of manual trial and error. For example, one test might consume 75% of an instance’s resources, and trying to run a second test that consumes 50% of an instance’s resources on the same instance can lead to unpredictable behavior or crashes. Test schedulers are forced to manually try different arrangements of tests to find tests that can run together on the same instance safely. Once the test scheduler adds in variables such as tests running differently under different system loads, it becomes nearly impossible to maximize instance resources manually.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIGS. 1A and 1B are a diagram illustrating operations and features of a system to optimize end-to-end computer system testing.

FIG. 2 is a diagram illustrating an example of central processing unit (CPU) usage by three processes executing in sequence in a single instance.

FIGS. 3A, 3B, and 3C are diagrams illustrating an example of central processing unit (CPU) usage by three processes executing in parallel in three separate single instances.

FIG. 4 is a diagram illustrating an example of central processing unit (CPU) usage by three processes executing in a stacked fashion in a single instance.

FIGS. 5A, 5B, 5C, and 5D are diagrams illustrating an example of central processing unit (CPU) usage by three processes executing in a stacked fashion in a single instance after consideration of user input test expectations.

FIG. 6 is a diagram of a computer system upon which one or more of the embodiments disclosed herein can execute.

### DETAILED DESCRIPTION

An embodiment relates to a method or process of optimizing computing resources in an instance during end-to-end computer system testing. The embodiment first learns everything it can about how each individual test runs. Each individual test is monitored as it runs over a time period, and in particular, the uses of the instance resources are monitored as the test runs. For example, the monitoring involves central processing unit (CPU) usage as the test runs, how much memory is used by the test, and how long does the test take to complete. Also, any other system resources are monitored while the test runs that could limit how many tasks can run simultaneously on the instance.

Also, for each individual test that is run, an embodiment determines how the test executes under different conditions of the instance. For example, it can be determined how each individual test is affected by the load of the instance (that is, the number of users using the instance), or how each individual test is affected when the test is run at different times of the day.

The data collected for each individual test are then used to train a machine learning algorithm. The training of the machine learning algorithm generates a model that provides an expectation of how each individual test will run at any given time under any given system load. A separate model is generated for each individual test.

After the training of the machine learning algorithm and the generation of the models, a user provides inputs that are reflective of the desired expectations for a test plan. For example, the user can indicate that the cost of the test should be minimized, or the user can indicate that the speed of the test should be maximized. The user may indicate that there is a desired day or time by which the test should be completed (that is, a desired end time for the test). The user can also indicate the maximum length of time for the test plan to run. The user can further indicate any other desired expectations for any particular test.

Additionally, the user can indicate a required mapping of individual test relationships. For example, a user can identify tests that cannot run at the same time as each other, tests that must be run at the same time as other tests, tests that must be completed before other tests are run, and tests that must not be completed before other tests complete. These are just examples, and the user can indicate any other relationships that may affect the order or timing of an individual test when run alongside other tests.

Using the generated models and the user input, an embodiment creates a test plan that has the following attributes. The embodiment determines the optimal number of instances to invoke for the totality of the tests. The embodiment also efficiently stacks as many tests as possible on each instance. If tests do not consume 100% of instance resources for a period of time, one or more other tests can be run simultaneously on the same instance during that period of time (as long as the combination of those tests does not consume 100% of required system resources and as long as those tests can be run simultaneously). A goal of the embodiment is to maximize the computing resources of the instances that have been purchased. Individual instance or test startup times can vary in order to help maintain the defined relationships of how and when the tests are run.

In actual end-to-end testing, an embodiment continues to learn by monitoring the end-to-end tests, and how these end-to-end tests run when run alongside other end-to-end tests. This continued learning strengthens the models produced by machine learning for how end-to-end tests run under various conditions. The embodiment also monitors for any changes in the end-to-end tests and reevaluates the behavior of the end-to-end tests. This reevaluation can be done by running the changed tests individually on a system container for a period of time, or by initially placing the test based on its previous run history and then monitoring the testing process to better tune run time system resource usage.

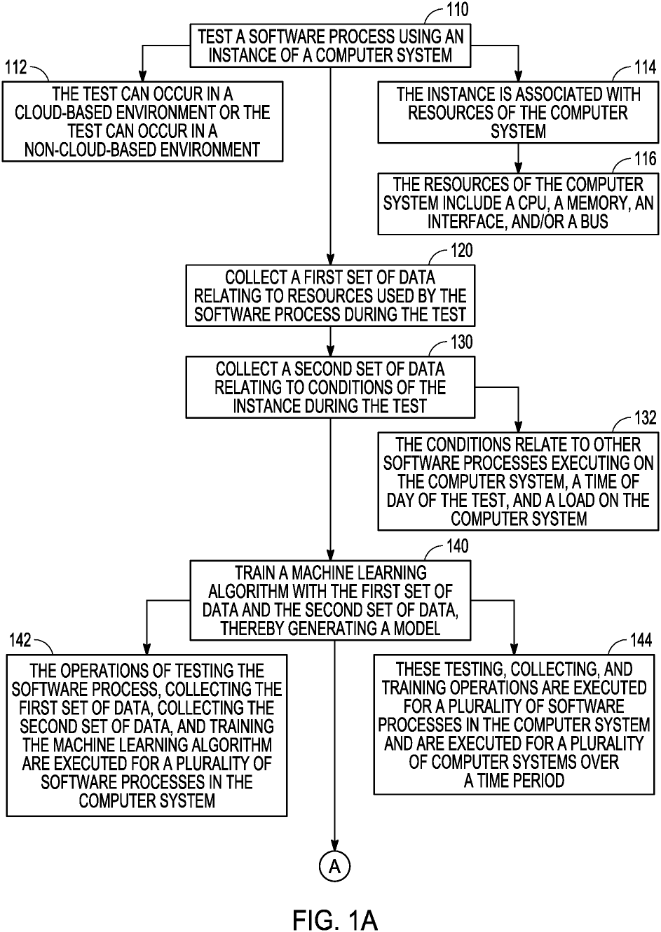

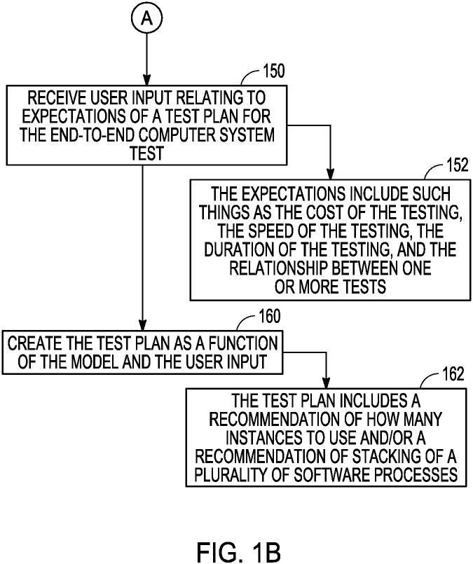

FIGS. 1A and 1B are a block diagram illustrating features and operations for optimizing an end-to-end computer system test. FIGS. 1A and 1B include a number of feature and process blocks 110 - 162. Though arranged substantially serially in the example of FIGS. 1A and 1B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring specifically now to FIGS. 1A and 1B, at 110, a software process is tested using an instance of a computer system. In an embodiment, there are many software processes that make up a particular system that is the subject of an end-to-end test, and each of these particular software processes are tested on the instance individually and separately from the other software tests that make up the system. As indicated at 112, the testing can occur in a cloud-based environment, or the testing can occur in a non-cloud-based environment, such as in one or more servers that are owned by a company. The instance is associated with one or more resources of the computer system (114), and the one or more resources of the computer system comprise one of more of a central processing unit (CPU), a memory, an interface, and a bus (116).

During this testing, as indicated at 120, a first set of data relating to resources used by the software process during the testing is collected, and as indicated at 130, a second set of data relating to conditions of the instance during the testing is collected. As noted at 132, the conditions relate to one or more other software processes executing on the computer system, a time of day of the testing, and a load on the computer system (number of users). Regarding the system load, if there are one million users actively using the system as compared to only one hundred users, a test will run slower when there are one million users on the system.

At 140, a machine learning algorithm is trained with the first set of data and the second set of data. This training results in a model for each of the software processes that relates to resources used by each software process under the conditions of the instance. As indicated at 142, the operations of testing the software process, collecting the first set of data, collecting the second set of data, and training the machine learning algorithm are executed for a plurality of software processes in the computer system. And as further indicated at 144, these testing, collecting, and training operations are executed for a plurality of software processes in the computer system and are executed for a plurality of computer systems over a time period. In these manners, the machine learning algorithm continuously learns over the time period.

After the training of the machine learning algorithm for each of the software processes, at 150, user input relating to one or more expectations of a test plan for the end-to-end computer system test is received. The expectations can include such things as the cost of the testing, the speed of the testing, the duration of the testing, and the relationship between one or more tests (152).

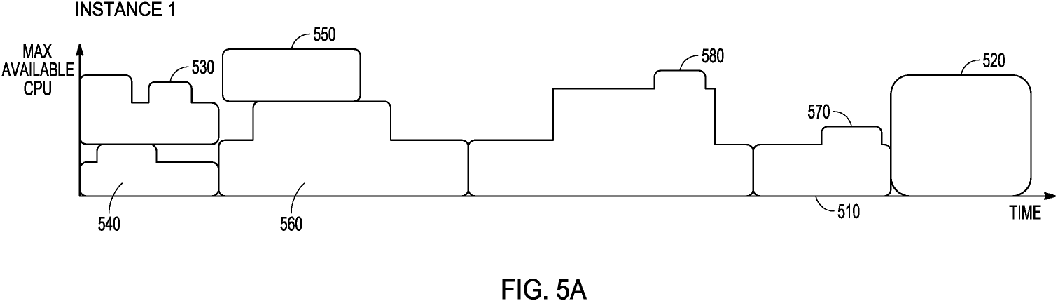

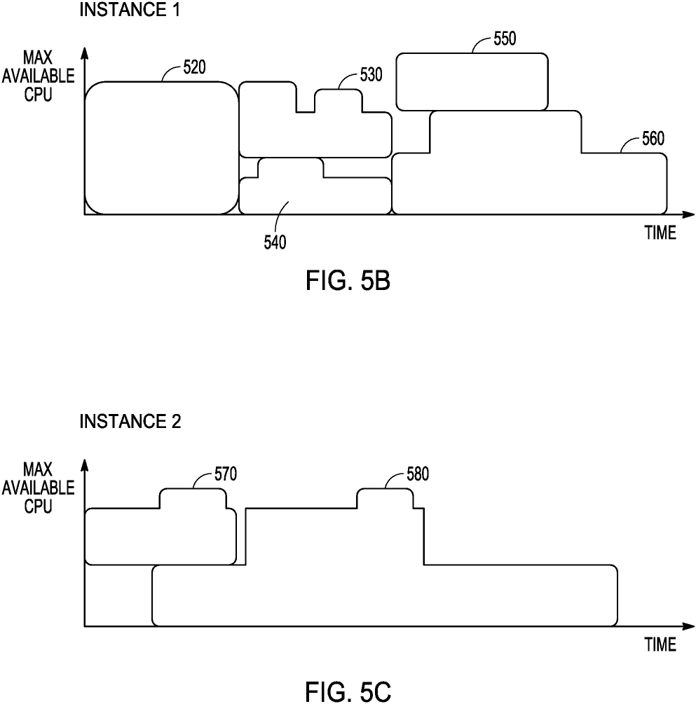

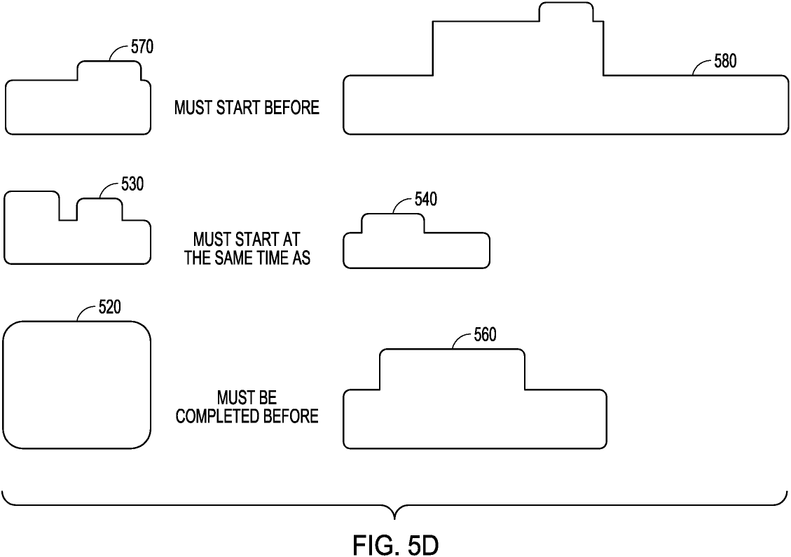

Thereafter, at 160, the test plan is created as a function of the model and the user input. The test plan can include a recommendation of how many instances to use and/or a recommendation of stacking of a plurality of software processes (162). As illustrated in FIG. 5B, the stacking of a plurality of software processes refers to multiple tests executing on the same instance, potentially at staggered times.

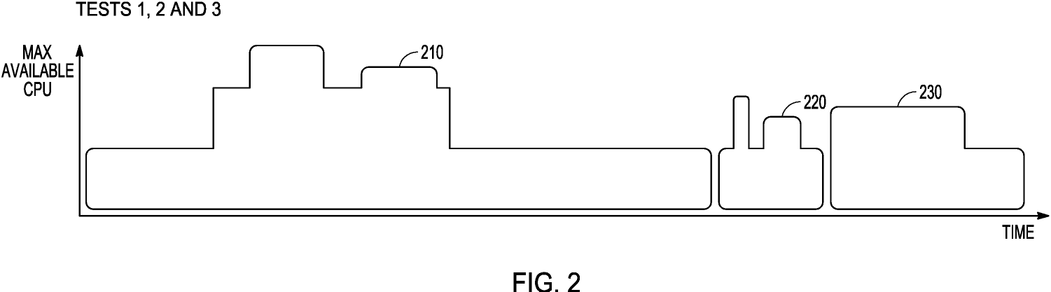

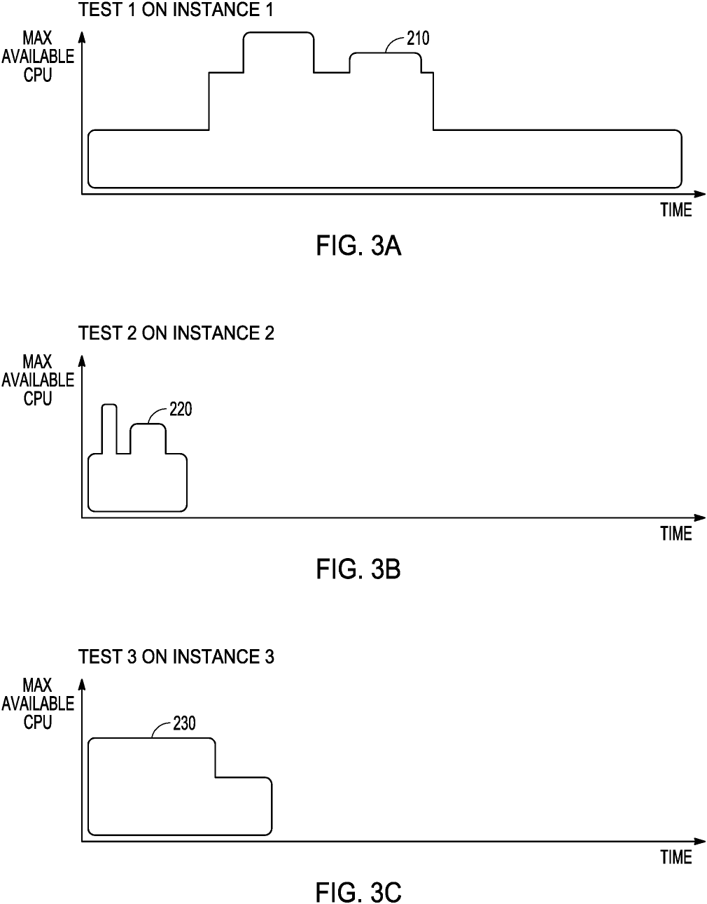

FIGS. 2, 3A, 3B, 3C, 4, 5A, 5B, 5C, and 5D further illustrate in a pictorial format the optimization of an end-to-end test using this embodiment. Referring first to FIGS. 2, 3A, 3B, and 3C, shortcomings of an end-to-end test that is run without the benefits of the embodiments of this disclosure are illustrated. FIG. 2 illustrates a conventional test wherein software process tests 210, 220, and 230 are each run sequentially on the same single instance. As illustrated in FIG. 2, test 210 is run until it completes. After test 210 has completed, test 220 is run, and then test 230 is run after test 220 has completed. The time to run this entire test (consisting of all three tests) is the TotalTime(Test 210) + TotalTime(Test 220) + TotalTime(Test 230). As can be seen from FIG. 2, there is unused (but paid for) CPU time and the test takes a longer time to run than if the tests 210, 220, and 230 were run in a more intelligent fashion.

FIGS. 3A, 3B, and 3C illustrate a manner in which the situation of FIG. 2 can be addressed. In FIGS. 3A, 3B, and 3C, the tests 210, 220, and 230 are executed in a different manner. Specifically, test 210 is run on instance no. 1, test 220 is run on instance no. 2, and test 230 is run on instance no. 3. The total time for the test is TotalTime(Test 210) (because it is the longest running test). However, the cost to run the tests in FIGS. 3A, 3B, and 3C is higher because there are costs associated with running each test on its own individual instance as discussed above.

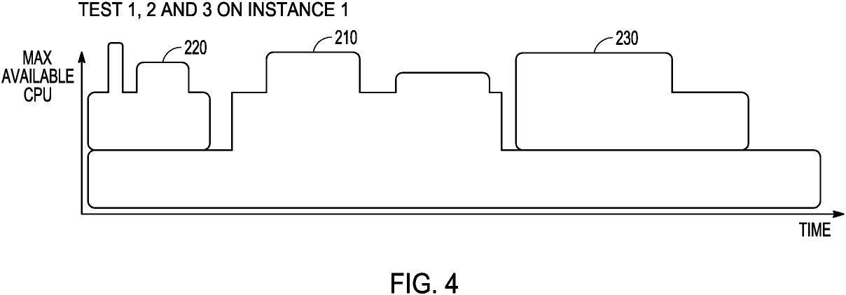

FIG. 4 is in contrast to FIGS. 2, 3A, 3B, and 3C. FIG. 4 illustrates a result of employing an embodiment of the present disclosure. Specifically, the trained models intelligently arrange the tests 210, 220, and 230 so that resources of the instance(s) are maximized. The cost of running tests 210, 220, and 230 is now the same as the cost of running just test 210 by itself. Also, the total time needed to run tests 210, 220, and 230 is now the same as the total time required to run test 210 by itself. That is, the total run time is TotalTime(Test 210), and the cost is at its lowest point as only a single instance is used.

As noted above, the machine learning algorithm is trained for each of the software processes (140). The trained model may indicate that an end-to-end test could be performed using only one instance, as illustrated in FIG. 5A. Therefore, in the situation of FIG. 5A, only one instance needs to be used, and most of the time the maximum amount of the CPU is being used (which as indicated above, is already paid for). However, as detailed above, an embodiment receives user input relating to one or more expectations of a test plan for the end-to-end computer system test (150). This user input may require that the end-to-end testing not exceed the time 510 in FIG. 5A, that test 520 must complete before test 560, that test 530 must start at the same time as test 540 and that test 570 must start before test 580 as illustrated in graphic format in FIG. 5D. Based on this user input, the embodiment then determines that while the model reports that only one instance is required, the user input of requirements and/or expectations “overrides” the model, and the embodiment determines that two instances are requires as illustrated in FIGS. 5B and 5C which illustrate the created test plan as a function of the model and the user input (160).

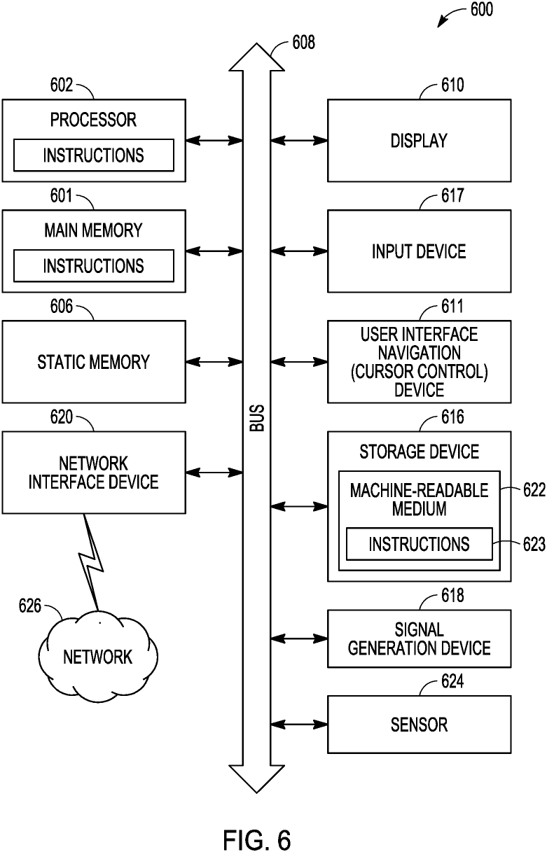

FIG. 6 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 601 and a static memory 606, which communicate with each other via a bus 608. The computer system 600 may further include a display unit 610, an alphanumeric input device 617 (e.g., a keyboard), and a user interface (UI) navigation device 611 (e.g., a mouse). In one embodiment, the display, input device and cursor control device are a touch screen display. The computer system 600 may additionally include a storage device 616 (e.g., drive unit), a signal generation device 618 (e.g., a speaker), a network interface device 620, and one or more sensors 624, such as a global positioning system sensor, compass, accelerometer, or other sensor.

The drive unit 616 includes a machine-readable medium 622 on which is stored one or more sets of instructions and data structures (e.g., software 623) embodying or utilized by any one or more of the methodologies or functions described herein. The software 623 may also reside, completely or at least partially, within the main memory 601 and/or within the processor 602 during execution thereof by the computer system 600, the main memory 601 and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 623 may further be transmitted or received over a communications network 626 using a transmission medium via the network interface device 620 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example No. 1 is a process for executing an end-to-end computer system test including testing a software process using an instance of a computer system; collecting a first set of data relating to resources used by the software process during the testing; collecting a second set of data relating to conditions of the instance during the testing; training a machine learning algorithm with the first set of data and the second set of data, thereby generating a model relating to the resources used by the software process under the conditions of the instance; receiving user input relating to one or more expectations of a test plan for the end-to-end computer system test; and creating the test plan as a function of the model and the user input.

Example No. 2 includes all the features of Example No. 1 and optionally includes a process wherein the testing the software process, the collecting the first set of data, the collecting the second set of data, and the training the machine learning algorithm are executed for a plurality of software processes in the computer system.

Example No. 3 includes all the features of Example Nos. 1-2 and optionally includes a process wherein the testing the software process, the collecting the first set of data, the collecting the second set of data, and the training the machine learning algorithm are executed for a plurality of software processes in the computer system and are executed for a plurality of computer systems over a time period, such that the machine learning algorithm continuously learns over the time period.

Example No. 4 includes all the features of Example Nos. 1-3 and optionally includes a process wherein the end-to-end computer system test occurs in a cloud-based computer environment.

Example No. 5 includes all the features of Example Nos. 1-4 and optionally includes a process wherein the end-to-end computer system test occurs in a non-cloud-based environment.

Example No. 6 includes all the features of Example Nos. 1-5 and optionally includes a process wherein the instance is associated with one or more resources of the computer system.

Example No. 7 includes all the features of Example Nos. 1-6 and optionally includes a process wherein the one or more resources of the computer system comprise one of more of a central processing unit (CPU), a memory, an interface, and a bus.

Example No. 8 includes all the features of Example Nos. 1-7 and optionally includes a process wherein the conditions relate to one or more other software processes executing on the computer system, a time of day of the testing, and a load on the computer system.

Example No. 9 includes all the features of Example Nos. 1-8 and optionally includes a process wherein the expectations comprise one or more of a cost of the testing, a speed of the testing, a duration of the testing, and a relationship between one or more tests.

Example No. 10 includes all the features of Example Nos. 1-9 and optionally includes a process wherein the test plan comprises one or more of a recommendation of how many instances to use and a recommendation of stacking of a plurality of software processes.

Example No. 11 is a non-transitory machine-readable medium including instructions that when executed by a processor executes a process of testing a software process using an instance of a computer system; collecting a first set of data relating to resources used by the software process during the testing; collecting a second set of data relating to conditions of the instance during the testing; training a machine learning algorithm with the first set of data and the second set of data, thereby generating a model relating to the resources used by the software process under the conditions of the instance; receiving user input relating to one or more expectations of a test plan for the end-to-end computer system test; and creating the test plan as a function of the model and the user input.

Example No. 12 includes all the features of Example No. 11 and optionally includes a non-transitory machine-readable medium wherein the testing the software process, the collecting the first set of data, the collecting the second set of data, and the training the machine learning algorithm are executed for a plurality of software processes in the computer system.

Example No. 13 includes all the features of Example Nos. 11-12 and optionally includes a non-transitory machine-readable medium wherein the testing the software process, the collecting the first set of data, the collecting the second set of data, and the training the machine learning algorithm are executed for a plurality of software processes in the computer system and are executed for a plurality of computer systems over a time period, such that the machine learning algorithm continuously learns over the time period.

Example No. 14 includes all the features of Example Nos. 11-13 and optionally includes a non-transitory machine-readable medium wherein the end-to-end computer system test occurs in a cloud-based computer environment.

Example No. 15 includes all the features of Example Nos. 11-14 and optionally includes a non-transitory machine-readable medium wherein the end-to-end computer system test occurs in a non-cloud-based environment.

Example No. 16 includes all the features of Example Nos. 11-15 and optionally includes a non-transitory machine-readable medium wherein the instance is associated with one or more resources of the computer system; and wherein the one or more resources of the computer system comprise one of more of a central processing unit (CPU), a memory, an interface, and a bus.

Example No. 17 includes all the features of Example Nos. 11-16 and optionally includes a non-transitory machine-readable medium wherein the conditions relate to one or more other software processes executing on the computer system, a time of day of the testing, and a load on the computer system.

Example No. 18 includes all the features of Example Nos. 11-17 and optionally includes a non-transitory machine-readable medium wherein the expectations comprise one or more of a cost of the testing, a speed of the testing, a duration of the testing, and a relationship between one or more tests.

Example No. 19 includes all the features of Example Nos. 11-18 and optionally includes a non-transitory machine-readable medium wherein the test plan comprises one or more of a recommendation of how many instances to use and a recommendation of stacking of a plurality of software processes.

Example No. 20 is a system including a computer processor and a computer memory coupled to the computer processor; wherein one or more of the computer processor and memory are operable for testing a software process using an instance of a computer system; collecting a first set of data relating to resources used by the software process during the testing; collecting a second set of data relating to conditions of the instance during the testing; training a machine learning algorithm with the first set of data and the second set of data, thereby generating a model relating to the resources used by the software process under the conditions of the instance; receiving user input relating to one or more expectations of a test plan for the end-to-end computer system test; and creating the test plan as a function of the model and the user input.

1. A process for executing an end-to-end computer system test comprising:
testing a software process using an instance of a computer system;
collecting a first set of data relating to resources used by the software process during the testing;
collecting a second set of data relating to conditions of the instance during the testing;
training a machine learning algorithm with the first set of data and the second set of data, thereby generating a model relating to the resources used by the software process under the conditions of the instance;
receiving user input relating to one or more expectations of a test plan for the end-to-end computer system test; and
creating the test plan as a function of the model and the user input.

2. The process of claim 1, wherein the testing the software process, the collecting the first set of data, the collecting the second set of data, and the training the machine learning algorithm are executed for a plurality of software processes in the computer system.

3. The process of claim 1, wherein the testing the software process, the collecting the first set of data, the collecting the second set of data, and the training the machine learning algorithm are executed for a plurality of software processes in the computer system and are executed for a plurality of computer systems over a time period, such that the machine learning algorithm continuously learns over the time period.

4. The process of claim 1, wherein the end-to-end computer system test occurs in a cloud-based computer environment.

5. The process of claim 1, wherein the end-to-end computer system test occurs in a non-cloud-based environment.

6. The process of claim 1, wherein the instance is associated with one or more resources of the computer system.

7. The process of claim 6, wherein the one or more resources of the computer system comprise one of more of a central processing unit (CPU), a memory, an interface, and a bus.

8. The process of claim 1, wherein the conditions relate to one or more other software processes executing on the computer system, a time of day of the testing, and a load on the computer system.

9. The process of claim 1, wherein the expectations comprise one or more of a cost of the testing, a speed of the testing, a duration of the testing, and a relationship between one or more tests.

10. The process of claim 1, wherein the test plan comprises one or more of a recommendation of how many instances to use and a recommendation of stacking of a plurality of software processes.

11. A non-transitory machine-readable medium comprising instructions that when executed by a processor executes a process comprising:
testing a software process using an instance of a computer system;
collecting a first set of data relating to resources used by the software process during the testing;
collecting a second set of data relating to conditions of the instance during the testing;
training a machine learning algorithm with the first set of data and the second set of data, thereby generating a model relating to the resources used by the software process under the conditions of the instance;
receiving user input relating to one or more expectations of a test plan for the end-to-end computer system test; and
creating the test plan as a function of the model and the user input.

12. The non-transitory machine-readable medium of claim 11, wherein the testing the software process, the collecting the first set of data, the collecting the second set of data, and the training the machine learning algorithm are executed for a plurality of software processes in the computer system.

13. The non-transitory machine-readable medium of claim 11, wherein the testing the software process, the collecting the first set of data, the collecting the second set of data, and the training the machine learning algorithm are executed for a plurality of software processes in the computer system and are executed for a plurality of computer systems over a time period, such that the machine learning algorithm continuously learns over the time period.

14. The non-transitory machine-readable medium of claim 1, wherein the end-to-end computer system test occurs in a cloud-based computer environment.

15. The non-transitory machine-readable medium of claim 11, wherein the end-to-end computer system test occurs in a non-cloud-based environment.

16. The non-transitory machine-readable medium of claim 11, wherein the instance is associated with one or more resources of the computer system; and wherein the one or more resources of the computer system comprise one of more of a central processing unit (CPU), a memory, an interface, and a bus.

17. The non-transitory machine-readable medium of claim 11, wherein the conditions relate to one or more other software processes executing on the computer system, a time of day of the testing, and a load on the computer system.

18. The non-transitory machine-readable medium of claim 11, wherein the expectations comprise one or more of a cost of the testing, a speed of the testing, a duration of the testing, and a relationship between one or more tests.

19. The non-transitory machine-readable medium of claim 11, wherein the test plan comprises one or more of a recommendation of how many instances to use and a recommendation of stacking of a plurality of software processes.

20. A system comprising:
a computer processor; and
a memory coupled to the computer processor;
wherein one or more of the computer processor and memory are operable for:
testing a software process using an instance of a computer system;
collecting a first set of data relating to resources used by the software process during the testing;
collecting a second set of data relating to conditions of the instance during the testing;
training a machine learning algorithm with the first set of data and the second set of data, thereby generating a model relating to the resources used by the software process under the conditions of the instance;
receiving user input relating to one or more expectations of a test plan for the end-to-end computer system test; and
creating the test plan as a function of the model and the user input.
